(19) United States
(12) Patent Application Publication
(10) Pub. No.: US 2013/0138555 A1
(43) Pub. Date: May 30, 2013

(54) SYSTEM AND METHOD OF INTERPRETING RESULTS BASED ON PUBLICLY AVAILABLE DATA

(71) Applicant: Rodion Shishkov, St. Petersburg (RU)

(72) Inventor: Rodion Shishkov, St. Petersburg (RU)

(73) Assignee: RAWLLIN INTERNATIONAL INC., Tortola (VG)

(21) Appl. No.: 13/307,637

(22) Filed: Nov. 30, 2011

(51) Int. Cl. G06Q 40/02

(52) U.S. Cl. 705/38

(57) ABSTRACT

Disclosed are systems and techniques that generate different sets of attributes for determining a credit worthiness score of a client. A first set of attributes is obtained from reliable data sources having information related to the client's credit score. A second set of attributes is obtained from publicly available data sources. The data is scored with respect to validity and relevancy to the potential client based on associations between the first and second set of attributes. A credit worthiness score is determined according to the first and the second set of data wherein the second set of attributes relates to characteristics of the client different from the first set of attributes.

### TECHNICAL FIELD

The subject application relates to obtaining publicly available data from data sources and interpreting search results based on the data obtained.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Additionally, consumers are frequently presented with opportunities to apply for instant approval for credit cards during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards, such as with college students trying to start careers for the first time or groups of elderly always wary of credit. In addition, some consumers choose not to use credit cards, or elect not to go through the application process at the time of the offer is presented.

Moreover, retailers often attempt to persuade consumers to purchase additional items, or items related to items that the consumer is purchasing. In order to tailor the suggestions to the desires of the consumer, some retailers employ loyalty cards that enable the retailer to monitor the buying patterns of the consumer. Similarly, online retailers often encourage consumers to maintain a user account with the retailer, and data tracked via the user account can be used to suggest purchase options, or tailor promotions based on the consumer's buying patterns. However, similar to instant credit card applications, some consumers choose not to go through the loyalty card application or online account setup process.

The above-described deficiencies of today's credit application and promotional tools lend for the need to better serve and target potential clients. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for determining credit worthiness based on publicly available data sources are contained herein. An exemplary method for a system comprises searching a first set of data sources with a search component to obtain a first set of search results having credit worthiness data that is associated with a client and a credit score of the client. The method continues with selecting a set of client data from at least part of the first set of search results, and searching the selected part against a second set of different data sources to obtain a second set of different search results. A credit worthiness score is then determined based on the second set of different search results and the first set of search results. The second set of data sources includes different data sources than the first set of data sources.

In still another non-limiting embodiment, an exemplary computer readable storage medium having computer executable instructions that, in response to execution by a computing system, cause the computing system to perform operations that comprise identifying a potential client for a financial loan. A first set of data sources is searched to obtain a first set of attributes that is associated with the potential client and a set of client data is selected from at least part of the first set of attributes from the first set of data sources. The selected part is then searched against a second set of different data sources to obtain a second set of different attributes, and a credit worthiness score is determined based on the set of client data and the second set of attributes. The second set of data sources includes different data sources than the first set of data sources. For example, the first set of data sources includes private data sources and the second set of data sources includes publicly available data sources.

In another non-limiting embodiment, a system is disclosed having a first attribute memory storage configured to store attribute data gathered about a client from a first set of data sources. A search component of the system is configured to receive key search terms related to the client, to search the first set of databases and to generate a first set of attributes that is related to calculating a credit score for the client from data sources of private entities. A profile analyzer of the system is configured to select the first set of search results, to generate a client profile with metadata associated with the client and to rank the metadata based on validity and relevance to the client. A second attribute memory storage is configured to store additional attribute data gathered about the client from a second set of data sources and an advisor component is coupled to the profile analyzer that is configured to factor a credit worthiness score based on the additional attribute data in the second attribute memory storage for the client.

### BRIEF DESCRIPTION OF DRAWINGS

FIG. 1 illustrates an example recommendation system in accordance with various aspects described herein;

FIG. 2 illustrates another example recommendation system in accordance with various aspects described herein;

FIG. 3 illustrates an example advisor component in accordance with various aspects described herein;

FIG. 4 illustrates another example recommendation system in accordance with various aspects described herein;

FIG. 5 illustrates an example graphical relationship for determining validity information dynamically in accordance with various aspects described herein;

FIG. 6 illustrates a flow diagram showing an exemplary non-limiting implementation for a recommendation system for recommending credit worthiness of a client in accordance with various aspects described herein;

FIG. 7 illustrates a flow diagram showing an exemplary non-limiting implementation for a recommendation system for recommending credit worthiness of a client in accordance with various aspects described herein;

FIG. 8 is a block diagram representing exemplary non-limiting networked environments in which various non-limiting embodiments described herein can be implemented;

FIG. 9 is a block diagram representing an exemplary non-limiting computing system or operating environment in which one or more aspects of various non-limiting embodiments described herein can be implemented; and

FIG. 10 is an illustration of an exemplary computer-readable medium comprising processor-executable instructions configured to embody one or more of the provisions set forth herein.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In consideration of the above-described deficiencies among other things, various embodiments are provided that dynamically interpret data related to clients for credit worthiness, and, more generally, is related to retrieving publicly available information, search engines, and information collected to generate a client profile for credit worthiness determinations based on publicly available data sources.

To determine the credit worthiness of a client for a small loan, a large loan or some other financial instrument, for example, information pertaining to the client's credit score is first obtained from private data sources and compiled into a client profile. The reliability of information ascertained from such private data sources can be associated with a higher confidence in validity compared to other public data pertaining to a particular client. This trusted information is utilized to search publicly available data sources to obtain search results that the client profile is dynamically updated with and used as a factor or a basis to determining a credit worthiness score of the client.

Searching of data sources is preformed in a recommendation system that builds the client profile and provides advice or recommendation to a user/vendor based upon the client profile. For example, validity measures are assigned to attribute data that is compiled in a client profile. These measures include scores that rank/rate validity and relevancy of the various characteristics of the client. The scores, for example, are determined based on frequency of occurrence within each search, the relationships or associations that the data has with data already compiled and data in each search result, a classification of the data, the data source in which the data originates, the number of relationships, and other weight factors for assessing validity and relevancy of data at each iteration of searching data sources. In response, an advisor component determines an offer to a client based at least in part on the publicly available data obtained from publicly available data bases including character, abilities and skills, associations the client has with others and their credit scores, and the like.

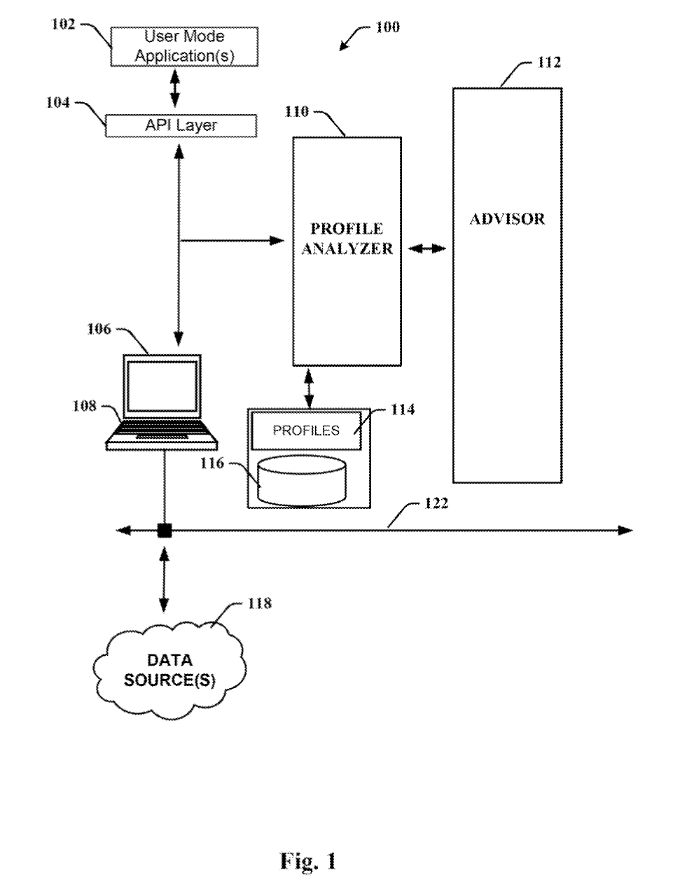

Referring initially to FIG. 1, illustrated is an example system 100 to output one or more recommendations pertaining to potential clients in accordance with various aspects described herein. The system 100 is operable as a recommendation system, such as to recommend credit to potential clients or to output other recommendations based on analysis of a dynamically and iteratively generated client profile and validation of the data related to the client profile.

The system 100 includes a user mode application 102 includes in either a remote client device (not shown) or a client device 106. The user mode application 102 requests various system functions by calling application programming interfaces (APIs) 104 for invoking a particular set of rules (code) and specifications that various computer programs interpret to communicate with each other. The API layer 104 thus serves as an interface between different software programs and facilitates their interaction. For accessing files stored on a remote network server (e.g., a file server with data sources 118), the application 102 places file input output (I/O) API calls directed to a network resource to an API layer 104. For example, applications can examine or access resources on remote systems by using a UNC (Uniform Naming Convention) standard with Win32 functions to directly address a remote resource, e.g., via a drive mapped to a network shared folder or the like.

A client device, such as a computer device 106 includes a memory for storing instructions that are executed via a processor (not shown). A bus 122 permits communication among the components of the system 100. The device 106 includes processing logic that may include a microprocessor or application specific integrated circuit (ASIC), a field programmable gate array (FPGA), or the like. The computer device 106 may also include a graphical processor (not shown) for processing instructions, programs or data structures for displaying a graphic, such as a three-dimensional scene or perspective view.

The device 106 includes an input device 108 that has one or more mechanisms in addition to a touch panel that permit a user to input information thereto, such as microphone, keypad, control buttons, a keyboard, a gesture-based device, an optical character recognition (OCR) based device, a joystick, a virtual keyboard, a speech-to-text engine, a mouse, a pen, voice recognition and/or biometric mechanisms, and the like.

The computer device 106 is coupled to a profile analyzer 110 that is operable to generate a profile 114 related to a certain client and store the data profile in a profile storage 116. The profile analyzer 110 is configured to retrieve a first set of search results from data sources 118 in response to a search query. The analyzer 110 is configured to generate a client profile 114 with metadata (e.g., attributes or characteristics) associated with the client and to rank the metadata according to a level of validity and/or relevance to the client according to a set of predetermined criteria. Characteristics or attributes are assimilated as metadata associated with the client profile 114 in storage 116, for example.

Initially, in order to qualify (approve) a candidate/applicant/client for a loan or other financial instrument, the lender needs to gather information about the client such as from online (Internet) public sources with, for example, search engines, social networks, blogs, media publications, and the like. Additionally, special data sources may be employed, such as credit reports, or agencies/bureaus with private data pertaining to the client's credit score rating (e.g., TransUnion, Equifax, Experion). Information about the client is searched with key search words (e.g., name, data of birth, email addresses, and the like. The data is collected and stored in the profile memory 114 having a profile data base 116 in the recommendation system 100. The profiles of each client contain client characteristic data that includes information collected over publicly available networks (e.g., Internet, etc.), which with some level of accuracy may belong to the client. Data is also scored with respect to validity and relevancy to the client depending upon associations or relationships that data searched has to the key terms and the information already stored in the client profile 114.

The profile storage memory 116 includes attributes from various types of data sources related to the client and a ranking of validity and relevancy based upon associations among the data. The memory 116 can include a random access memory (RAM) or another type of dynamic storage device that may store information and instructions for execution by the processor or the analyzer 110, a read only memory (ROM) or another type of static storage device that may store static information and instructions for use by processing logic; a flash memory (e.g., an electrically erasable programmable read only memory (EEPROM)) device for storing information and instructions, and/or some other type of magnetic or optical recording medium and its corresponding drive.

The data sources 118 can include virtually any open source or publicly available sources of information, including but not limited to websites, search engine results, social networking websites, online resume databases, job boards, government records, online groups, payment processing services, online subscriptions, and so forth. In addition, the data sources 118 can include private databases, such as credit reports, loan applications, and so forth.

The system 100 further includes an advisor component 112 that communicates with the profile analyzer 110. Based on predetermined criteria such as information obtained from official data sources and information obtained from publicly available data sources, the advisor component 112 outputs recommendations for providing credit, a loan or other financial instrument to a client. Rather than only basing recommendations on financial data, the advisor component 112 determines recommendation on publicly available data such as the interest, abilities, skills, temperament, associations and character aspects of the client.

An advantage of assessing financial risk or recommendation for credit on publicly available data is providing wider latitude to consumers needing such instruments. In particular, small business loans can be based on factors that do not require strict criteria, but can be assessed more heavily based on a person's character, which is ascertained from among known public data available beyond financial numbers.

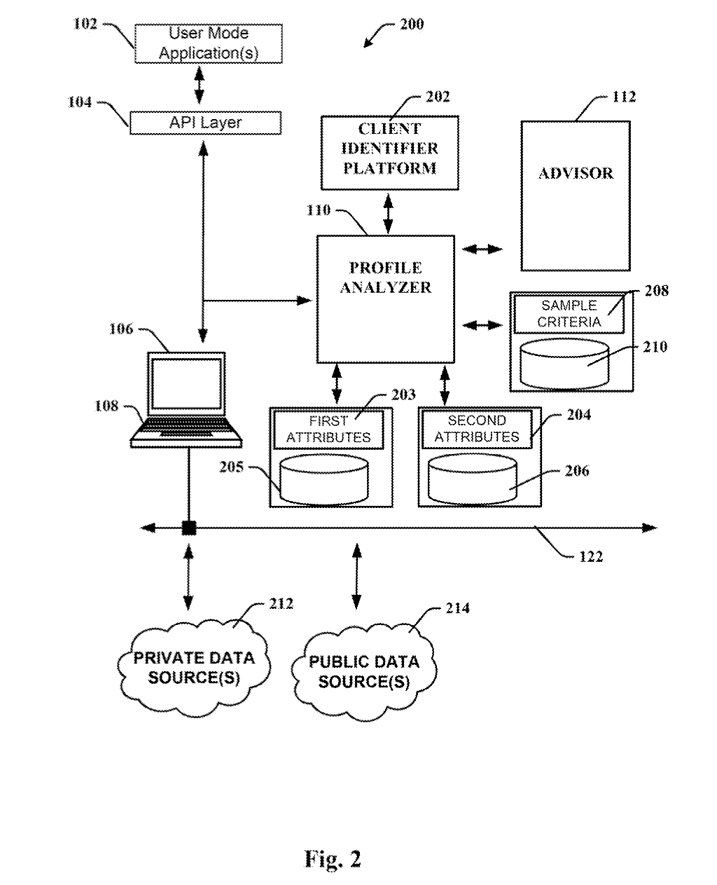

FIG. 2 illustrates a system 200 that generates recommendations regarding a client in accordance with exemplary aspects disclosed herein. The system 200 includes similar features disclosed above in regard to FIG. 1 and further includes a client identifier platform 202 coupled to the profile analyzer 110. A first set of attributes 203 stored in data base 205 and a second set of attributes 204 stored in data base 206 are further coupled to the profile analyzer. A set of sample criteria 208 is further stored in a sample criteria data base 210.

The client identifier platform 202 establishes initial candidates for the recommendation system 200 according to certain criteria 208 stored in the sample criteria memory 210. The client identifier platform 202 therefore enables the system 200 to monitor online user activities and attempts to recognize those that may respond to an offer of a financial instrument or a loan offer. In response, the advisor unit 112 organizes the different types of data with the terms of an offer to generate for the client. For example, an ecommerce activity is monitored and a failed transaction, or an observed needs based on the client's shopping habits or financial history may identify the client as a potential for needing a loan. Other such criteria that maybe used to identify a candidate for a loan include the denial of a credit application, a bounced check, an application being submitted for a layaway plan, an in store credit request being denied or some other like financial failure condition. A credit report and a formal application requirement may then be waived for the clients identified.

The first 203 and the second set of attributes 204 are used to form a client profile such as the profile 114. The first set of attributes 203 only include validated information, which belongs to a given user with a high level of probability or validity score (e.g., job, email usernames, name date, address, and the like). The second set of attribute data 204 include less valid information or information that varies in the level of validity. For example, search object online preferences, usage statistics, interests, hobbies, and other characteristic related traits such as skills, abilities, temperament, associations, etc. The sample criteria 208 may further include examples of recommendations, which may be configured per system owner requirement and used to provide standards to the profile analyzer 110 to produce decisions regarding recommendations.

In one embodiment, an initial search is performed pertaining to the client for private information related to a credit score and against private data sources 212. Alternatively, both private and public data sources are searched for data relevant to the client. The attributes related to the client are selected from among the search results and are then stored as the first set of attributes 203 in the database 205 where data with a high confidence/validity level is stored. A different search is then performed by the device for the second set of attributes 204. The second search may be performed with the data from the first set of attributes 203 within public data sources 214. The second set of attributes includes information related to personal characteristics of the client, such as temperament, abilities, personality characteristics, skills, talents, associations with others or friendships, the association's related credit score data and the like. A credit worthiness score is then determined by the advisor 112.

In one embodiment, the analyzer 110 can determine the potential client's or customer's offer eligibility based on the attributes pertaining to the potential client satisfying a set of predetermined criteria, which can be defined in the sample criteria 208. For example, eligibility for a loan can be based on the attributes meeting a threshold, either above or below a minimum or a maximum threshold. The predetermined criteria include validity and relevance of the data that has been updated by modified searching or augmented search data. For instance, if the potential client attributes satisfy a predetermined set of loan criteria, then the analyzer 110 can determine that the potential client is eligible for one or more loans.

It is to be appreciated that although the set of attributes 203 and 204 are illustrated as being stored in a data store, such implementation is not so limited. For instance, the attributes can be associated with an online shopping portal, stored in a cloud based storage system, or the data storage 205 and 206 can be included in the analyzer 110. In addition, it is to be appreciated that although the analyzer 110 is illustrated as a stand-alone component, such implementation is not so limited. For instance, the analyzer 110 can be associated with or included in a software application, an online shopping portal, and so forth.

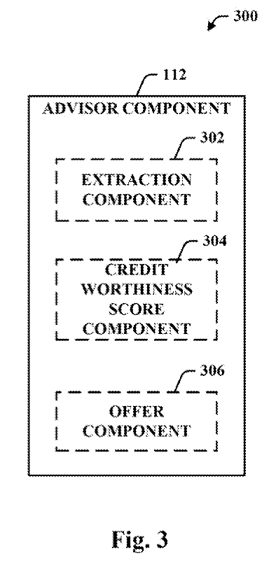

Referring now to FIG. 3, illustrates an exemplary advisor component 300. The component 112 includes an extraction component 302, a credit-worthiness score component 304 and an offer component 306. Each component is communicatively coupled to one another to dynamically generate an output based upon a dynamically generated client profile regarding a potential client.

The extraction component 302 retrieves, obtains or otherwise extracts data from the profile analyzer 110. Data is also communicated to the advisor component 602 from the system 100, for example, and received at the extraction component 302. The extraction component 302 retrieves data needed to provide a recommended output to a user of the system. For example, a potential client may be provided a loan offer, a set of financial instruments approved for, and/or a range of investment offers. The extraction component 302 communicates the data as an interface to the credit worthiness score component 304. A client's credit score is calculated at the credit-worthiness component based on the data dynamically updated in the client's profile and communicated by the extraction component 302. The score may be any scored weighted with different factors in an equation or algorithm as one of ordinary skill in the art will appreciate. For example, the validity and relevance of the data accumulated about the client is used as a factor or as the basis for a credit-worthiness score calculation. The offer component 306 then provides various terms, instruments, ranges, financial numbers and the like for presenting to the client.

Additionally, the offer component 306 intelligently determines or infers categorization of the profile 114, approval for one or more offers, or a set of terms for the offers. Any of the foregoing inferences can potentially be based upon, e.g., Bayesian probabilities or confidence measures or based upon machine learning techniques related to historical analysis, feedback, and/or other determinations or inferences.

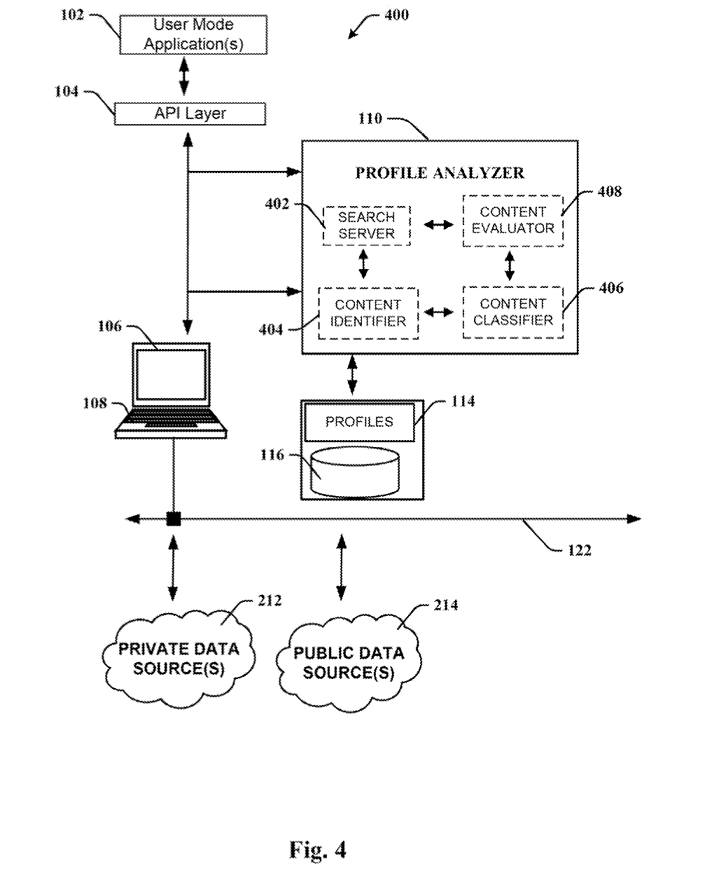

Referring now to FIG. 4, illustrates a system 400 having the profile analyzer 110. The profile analyzer 110 includes various components for identifying, classifying, organizing and evaluating client attribute data obtained from the first set of private data sources 212 and the second set of public data sources 214. The profile analyzer 110 includes a searcher server 402, a content identifier 404, a content classifier 406 and a content evaluator 408.

In one embodiment, the analyzer 110 receives one or more identification data associated with a client identified, which is used as search data or key search terms in the search server 402. For example, the identification data can include, but are not limited to a potential client's name, a date of birth, an email address, a geographical region, a home address, a phone number, a gender, a symbol and the like. Other identifying data may also be included, such as a history of transactions with a vendor or user of the recommendation system. For example, where a loan processing recommendation is the desired output from the recommendation system, the identifying data searched may be the history of usage with the financial services of the financial institution or lender.

The analyzer 110 acquires data, for example, relating to a person that is the potential client by searching a set of data sources 212 and/or 214. Using the content identifier 404, the profile analyzer 110 selects identifying data about a client according to predetermined criteria 208 (in FIG. 2, for example), and stores a set of attributes from the search results, which are then used to generate and update the client's profile 114. In one embodiment, the processing device 106 has an interface communicatively coupled thereto, such as a user interface, GUI or the like and further provides interaction with the profiles 114. For example, a manual search and additional automatic searching with different algorithms could provide input to the search results of the content identifier 404 in order to supplement content already identified.

The initial identifying data may be any data known about the client, such as a name or symbol to provide the basis for search query, in which a high reliability is associated therewith. This identifying data is reliable data that has a high reliability score such as data retrieved from official private data sources 212. For example, identifying data from various credit agencies (e.g., TranUnion, Experion, Equifax), vendor stored databases, or any other official/private data source that is trusted for reliability is used as the initial identifying data for searching the potential client among public data sources or data sources that are always publicly available. Data that may be initially searched with high reliability may be a client's name, email address, geographical address, transaction history and the like.

The analyzer 110 is further configured to determine that a set of information in the search results is relevant to the potential client, and includes attribute information in the profile 114 as metadata with the content classifier 406. The metadata stored in data storage 116 is further ranked according to a validation measure and is augmented to the first set of identifying data for further defining search terms in further searches for information pertaining to the client. For example, a name may be used to generate a first set of search results for the set of attributes stored as metadata. The metadata is weighted or associated with the name to varying degrees so that the weight of each association, for example, may vary depending upon the manner in which the metadata relates to the name. For example, a frequency or a number of times the name is associated with each search result may be ranked together and in addition based upon metadata accumulated in an aggregate data store of the client profile. For example, an alias or nickname for the name being searched may appear a number of times over multiple searches over time, and/or be a search result that is generated in conjunction with other metadata, and thus, indicate a higher likelihood that the data is correct or valid, or in some cases, a lower likelihood could be indicated.

In a further example, the system 400 collects and analyzes all data, and each data object is ranked by a reliability score, based on the source from which it is obtained. Later, such data paired with additional obtained information may change the reliability score. For example, the profile analyzer 110 could provide a reliability score that indicates an email address belongs to a person named Jack, but based on the source, the score is decreased since there is a lower confidence value associated with it, as opposed to other confidence values or reliability scores within the same scale. Later, the system may obtain the same email address from several other low reliability sources, but based on the fact of frequency of occurrence and that no other email address is known, and based on the assumption that everyone has at least one email address, the profile analyzer 110 could provide a strong reliability score as the object information (e.g., Jack's email address) is upgraded, which could also be downgraded later with subsequent searching and as information changes.

The sources of information, such as LinkedIn, other social networking sites, and the like could be ranked on a scale, such as a weighted score from 1 to 10, a decimal, binary or other scale according to predetermined criteria that weighs factors according to an algorithm or by a manual setting of the weight. For example, LinkedIn could have high reliability score based on the information structure and the crowd verification model, as such a score of nine to 10 could be given on a scale of 1 to 10 for this source of information's reliability.

The validation measure includes a validation score that could be in different forms and is not limited to any one weight mechanism. For example, a weighted mechanism can include a binary digit, decimal digit, any other numbering system of a different base, a scale (e.g., from one to ten), graphical weight, and the like. Each weighted association thus provides an indication of a strength of a relationship between data retrieved and data stored and each subsequent search further refines the validation strength of identifying data stored in the client's profile 114. The data retrieved, for example, comprises the search results for each search that is dynamically and iteratively generated with modified or augmented identifying data from the profile 114 compiled from previous searches of data sources.

The content evaluator 408 further examines the profile 114, and determines validity measures for the identifying data 104 and metadata stored. The measure can be associated with each metadata indicating a strength of relevance and/or reliability to the client attribute data in the profile 114. Additionally, the validation measure may correspond to relationships of data in the searched results with other metadata in the client profile. For example, if an email for a potential client is searched as the initial identifying data, the results may include different domain names in conjunction with dates of birth. A domain name associated with a data of birth for the user name of the email as stored in the client profile would have a higher score for reliance and/or validity than a domain name by itself.

Further, a validation measure can be provided by the validation module 408 based on a frequency of hits or search results for the given piece of data retrieved. For example, where a client's email is searched, such as with a user name as the identifying data, a domain name occurrence within the results having a greater frequency than others would indicate strong association with the user name, and thus, be afforded a greater validation measure and ranked greater according to a given scale. The ranking or measure may be a binary, decimal, scaled on a range, or some weight provided to indicate a relative association strength.

The profile analyzer 102 is further configured to provide a dynamic search process to the search engine 204 by continuously and iteratively evaluating content with the content evaluator 408 at each search cycle. According to the rankings or validity measures provided to the data and various relationships of the metadata stored in the client's profile 114, the profile analyzer 110 can select data to be further search data and/or modifies the search data to increase accuracy and/or relevancy for further information and further validation of the metadata associated in the client's profile 114. Therefore, an iterative and dynamic search process is performed with each cycle increasing the accuracy, amount, and relevance of the client profile information. Some metadata could be discarded dynamically. For example, where an address has been discovered to have been changed according to a strong validation measure being associated with a new address. Likewise, additional data discovered with modified/augmented identifying data searched by the server 402 may be added to the client's profile. The various rankings are further updated with each new augmented or modified search that indicates a change in relationship of the data and/or a frequency of occurrences in association with the identifying data of each iterative search.

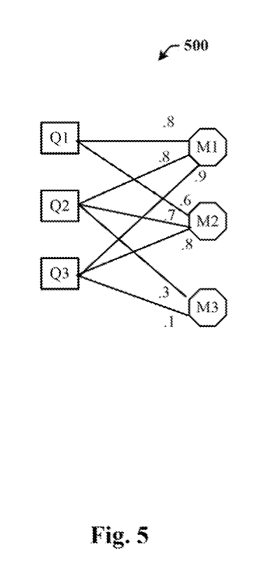

For example, FIG. 5 illustrates a graph 500 that provides for different search queries (e.g., Q1, Q2, and Q3). Q1 initiates with a set of identifying data that is searched and that relates to a potential client. The search results found are M1 and M2 and an initial validation score is determined by as 0.8 and 0.6 at each relationship, as indicated by the lines connecting Q1 with M1 and M2.

For example, an initial search cycle based on keywords or identifying data using the name: Jack Smith, data of birth: 26 Jan. 1916 and email: address@email.com. The results returned a new email address, a pseudo-name from a social network, an alias, a blog nickname, a service username, and/or any other character data related. Subsequently, in a further search (e.g., Q2, Q3, etc.) the results are employed to modify the existing data in Q1 or add to the data already stored from previous search results.

Subsequently, Q2 is a modified search that is performed with augmented or changed identifying data or search terms. In other words, new information resulting from M1 and M2 may supplement the identifying data or search terms used in Q1. Alternatively, Q2 is updated data resulting from a search with Q1, such as a new address or the like. Each data is relevant to different degrees to the creditworthiness of the potential client, and thus, is searched to determine and iteratively increase improve the validity and accuracy. Subsequently, Q2 is searched and returns M1, M2 and also M3 pieces of data related to the searched information data. According, to the different relationships analyzed by the relationship indicator 404, the validation score engine 402 provides a scored to each relationship, and/or to each a piece of metadata M1, M2 and M3. In addition, each new search, such as M3 further improves the calculation and either confirms the validity or negates the metadata discovered as not valid. In addition, scores may change not only as new data is discover (e.g., M3), but also as data from previous results has a difference in frequency in relation to the identifying data in used in the search or is further related to other metadata either used as search terms or stored in the profile of the client.

For example, before each new search cycle is started, the new attributes or related metadata affiliated to the potential client needs to be confirmed. This may be done by assigning a rating to each match. A higher rating or validation score from the validation engine 402 indicates a higher level of certainty that information belongs to the search subject and is valid. For example, an email address is a unique ID, therefore, if discovered that a user profile includes the same email address, there is a very high level of certainty attributed to the email address. Alternatively, matching a name or date of birth offers considerably low level of certainty. However, matching the name and the date of birth improves the quality of the match. Similarly, although a username usually is a unique ID within the same domain, it may belong to a different entity at a different domain. Although matching a name, date of birth and the username from two different domains provides very high probability that one and the other entities are the same.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

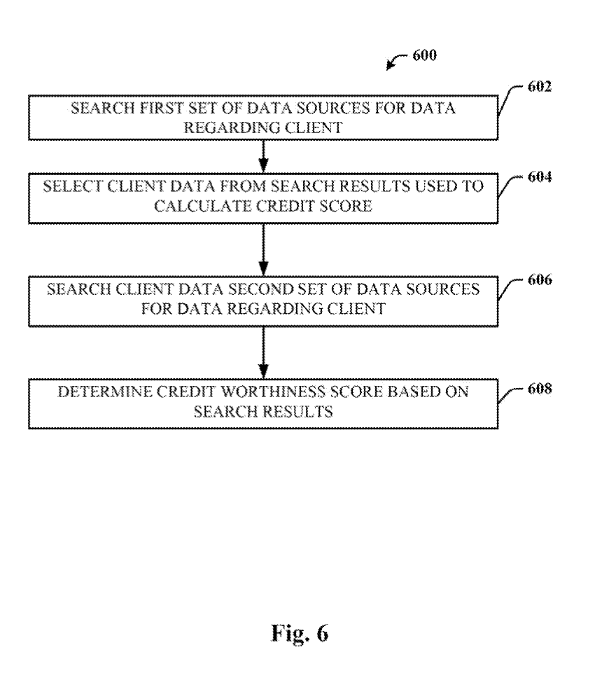

An example methodology 600 for implementing a method for a recommendation system is illustrated in FIG. 6. Reference is made to the figures described above for ease of description. However, the method 600 is not limited to any particular embodiment or example provided within this disclosure.

FIG. 6 illustrates the exemplary method 600 for a system in accordance with aspects described herein. The method 600, for example, provides for a system to interpret search results from publicly available data for financial credit in order to determine a credit worthiness score of a client. An output or recommendation, such as a recommendation for a loan is based on an assessment of validity and relevancy of the data together with factors pertaining to the client's character as gleaned from publicly available data sources. Consequently, a more accurate and reliable profile of a potential client is obtained to serve a ready credit worthiness score on behalf of potential clients before even applying for a loan or other financial arrangement.

At 602, a set of data sources is searched for data regarding a client that has been identified. The client is identified by monitoring activities via ecommerce, over the internet, historical transactions with a user/vendor, and any other participating methods such as via loyalty cards, club memberships, surveys, or via an express interest by the client. A search is conducted via a search engine of a financial recommendation system for attributes or financial information pertaining to the client's credit score. In one embodiment, a set of private data bases is used to obtain private financial information, such as the client's name, date of birth, employment place, social security, tax information, and the like. This information or first set of attributes collected is then stored in a first memory storage and is used to base further searching of a second set of attributes related to the client's personal attributes or personality characteristics.

At 604, client data is selected from search results resulting from a query of the first set of data sources. The data is selected as client data based on information pertaining to a credit score for the client. A credit score, for example, is a number expression representing the creditworthiness of a person, the likelihood that person will pay his or her debts. Lenders, such as banks and credit card companies, use credit scores to evaluate the potential risk posed by lending money to consumers. Widespread use of credit scores has made credit more widely available and cheaper for consumers, but credit scores have their limitations in assessing risk for a vendor and providing a basis for credit extension. In one embodiment, information is selected from private data sources in order to further research other attributes such as character related attributes of a client and store them in a separate memory. The result of the character search is then provided to supplement credit score data or to solely base credit offers thereon.

Information selected from the private data sources may include name, age, gender, email, region of residence, phone number, payment history, credit utilization, length of credit history, recent searches or credit inquires, credit limits, debt to income ratios, and like data. The sources can reliably validate data to a greater extend due to the economics of the data source using the data.

At 606, client data is further searched in a second set of data sources for data or a second set of attributes pertaining to the client's person. The second set of data include such attributes like character related traits, abilities, skills, temperament, affiliation with other clients and their credit score data, abilities, talents, credentials and the like. While this type of non-traditional data may not be practical for some credit extensions or instruments, and only one set of data may be needed depending on the results of the first search, other financial products may benefit to configuring credit scores based on an analysis that factors in more heavily character traits such as for small business loans or another type of small loan. Alternatively, a credit worthiness score of the client is calculate only on this type of data gathered from only publicly available data sources. The credit worthiness score therefore relates solely to the person's character and attributes from the second set of attributes.

At 608, the information obtained on the client is used to determine a credit worthiness score based on the first and/or second set of search results. In this manner, other factors are considered and employed in recommendation systems. For example, attributes search for in public sources available on public networks may include age, dependents or children, profession, spouse profession, area/region of employment, applicant income, area/region of residence, home ownership/home value, phone number, years at current residence, years at current job, years the client has conducted business with the user/lender, credit/debit account availability, hobby, interests, preferences, internet activity statistics, payment delinquencies, other financial failures and the like character related traits.

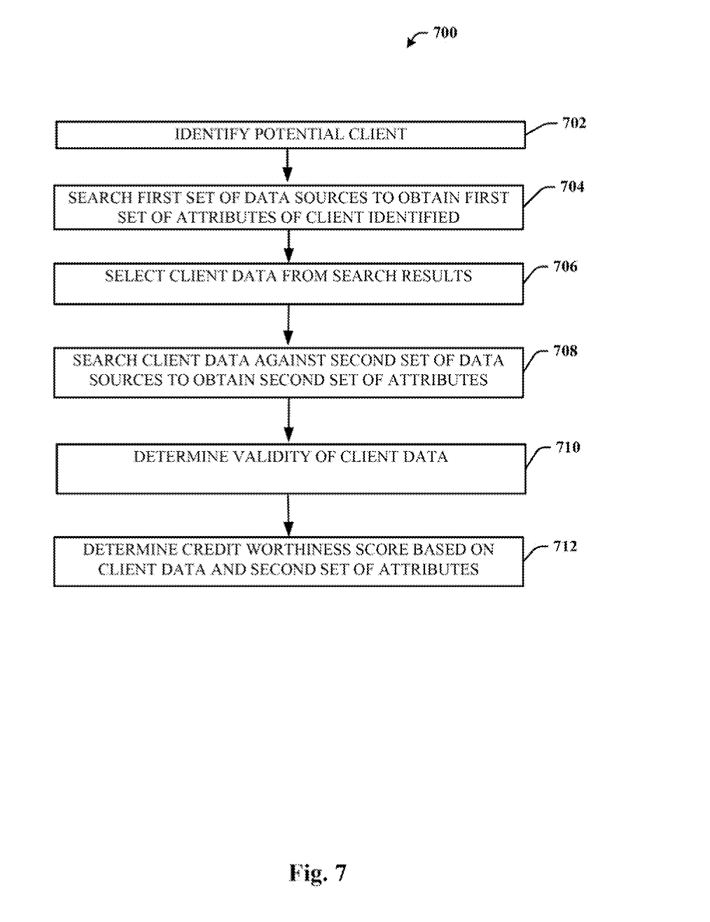

An example methodology 700 for implementing a method for a system such as a recommendation system is illustrated in FIG. 7. Reference may be made to the figures described above for ease of description. However, the method 700 is not limited to any particular embodiment or example provided within this disclosure.

The method 700, for example, provides for a system to iteratively and dynamically search data regarding a potential client based on automatic augmentation or modification of the search terms (e.g., identifying data) related to the client while also dynamically and iteratively validating the data stored in a profile from each search. At 702 a candidate or potential client is identified with a content identification platform, for example. Depending upon criteria such as a failed financial condition, or other condition, a client is marketed to with a recommended loan according to dynamic searching of attributes related to his or her person. For example, abilities, skills, temperament, interests, online preferences, usage statistics, history, application denial, credit denial, and the like criteria or conditions may be used to identify a client. A profile can be generated with candidate or client attribute metadata, which is based upon search results of data that identifies the candidate. For example, the search terms can include a first name, a last name, a date of birth, age, an email address, user name, domain name, geographical residence, telephone number, history and the like.

At 704, a search is performed that queries attributes pertaining to the identified client. A first set of data sources that includes private data sources is queried to obtain data related to the client that is reliable. At 706, client data is selected from the search results that have a high reliability factor. As discussed previously, the identifying data can be received from the user, extracted from a form or application, a disparate user (e.g., customer service representative, agent, etc.), obtained from a data store, or an associated profile and from any trusted source of data such as a credit agency or bureau. A first set of attributes is further compiled in a data base.

At 708, client data is searched against a second set of data sources to obtain a second set of attributes. A second set of attributes, for example, can include characteristics related to the client's character or personality, such as temperament or factors related to temperament, abilities, skills, interests and the like. All of these attributes are collected according to characteristics determined from the search results of the second set of attributes. Additional, attributes are also included in the second set of attributes that include associations with others and their respective credit scores, as well as a strength of relationships that the client has with each person.

At 710, validity of the client data is determined according to validity scores or confidence scores that are based on a frequency of occurrence with the attributes in the search results and/or a number of associations between the data first and second set of attributes. For example, where a name is associated with an interest and an email domain already obtained, the interest would have a higher validity score than just being associated with only the name. The scores be any type of range, scale, binary and the like. For example, a zero may indicate a lower validity and 1 a higher level of validity. Alternatively, a scale of 1 to 10 is used for assessing of valuating such validity.

At 712, a credit worthiness scored is determined based on the client data and the second set of attributes. The credit worthiness score is a score that indicates an amount for a loan offer or the risk associated with defaulting on an amount for a loan. The credit worthiness score is determined according to the second set of attributes. In addition, the validity determined to be association with each of the attributes in the second set can also be used to factor in the credit worthiness score and the data used in factoring the score.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

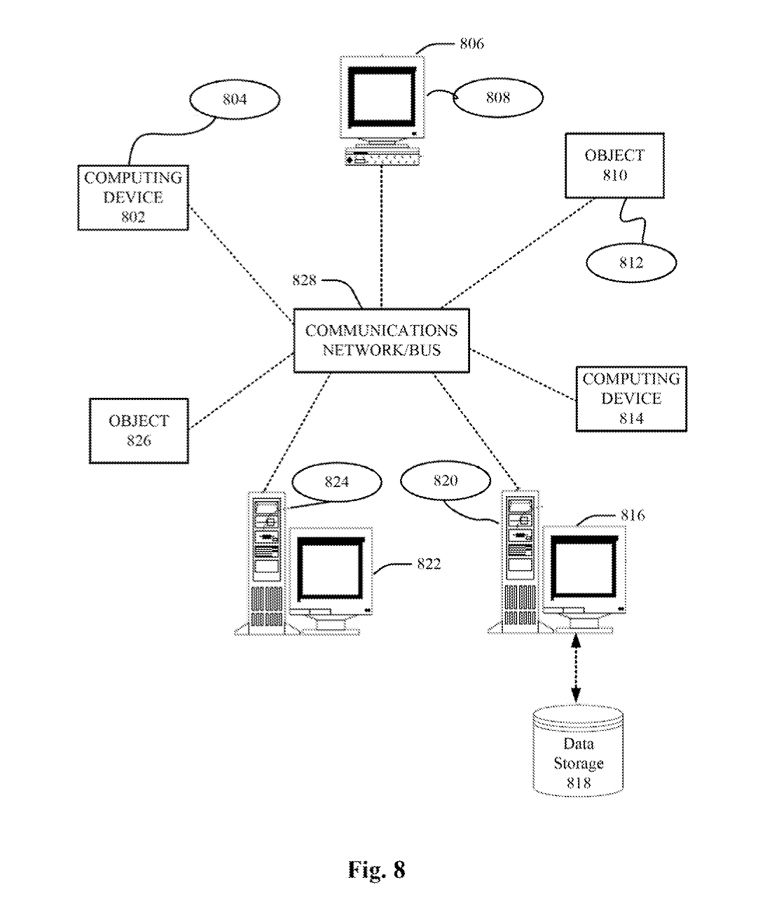

FIG. 8 provides a schematic diagram of an exemplary networked or distributed computing environment. The distributed computing environment comprises computing objects 810, 812, etc. and computing objects or devices 820, 822, 824, 826, 828, etc., which may include programs, methods, data stores, programmable logic, etc., as represented by applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 may comprise other computing objects and computing devices that provide services to the system of FIG. 8, and/or may represent multiple interconnected networks, which are not shown. Each computing object 810, 812, etc. or computing object or device 820, 822, 824, 826, 828, etc. can also contain an application, such as applications 830, 832, 834, 836, 838, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc., acting as servers provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 840 or bus is the Internet, for example, the computing objects 810, 812, etc. can be Web servers with which other computing objects or devices 820, 822, 824, 826, 828, etc. communicate via any of a number of known protocols, such as the hypertext transfer protocol (HTTP). Computing objects 810, 812, etc. acting as servers may also serve as clients, e.g., computing objects or devices 820, 822, 824, 826, 828, etc., as may be characteristic of a distributed computing environment.

### Exemplary Computing Device

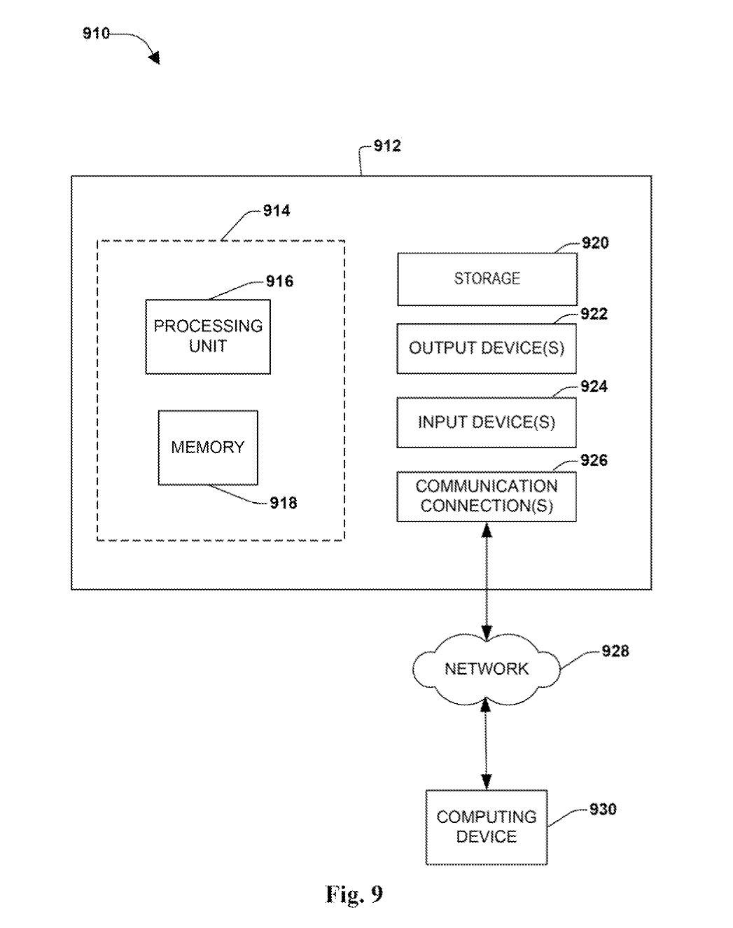

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 9 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 9 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 918 and storage 920 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

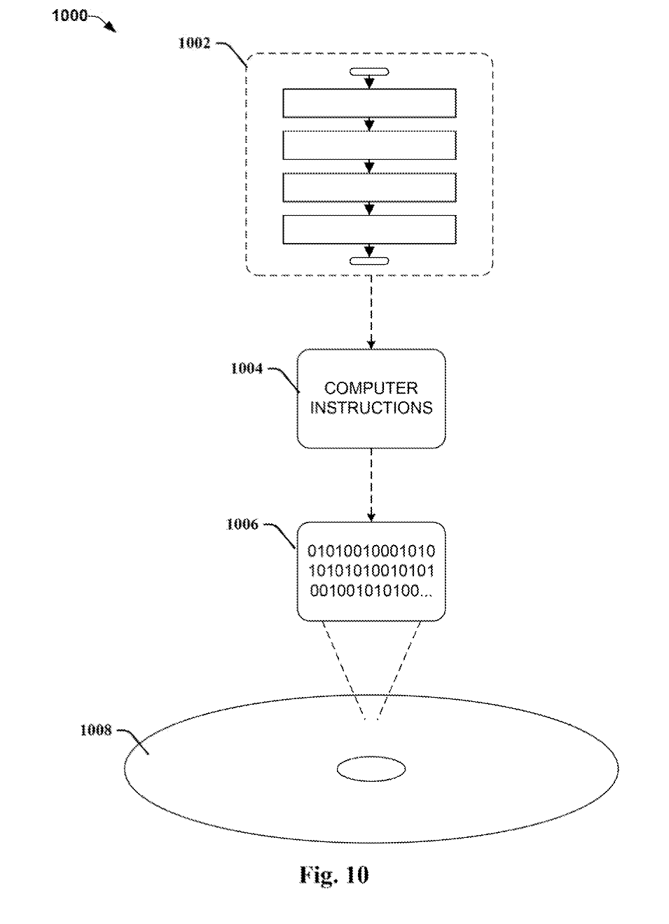

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1008 (e.g., a CD-R, DVD-R, or a platter of a hard disk drive), on which is encoded computer-readable data 1006. This computer-readable data 1006 in turn comprises a set of computer instructions 1004 configured to operate according to one or more of the principles set forth herein. In one such embodiment 1000, the processor-executable instructions 1004 may be configured to perform a method, such as the exemplary methods disclosed herein, for example. In another such embodiment, the processor-executable instructions X may be configured to implement a system, such as the exemplary systems herein, for example. Many such computer-readable media may be devised by those of ordinary skill in the art that are configured to operate in accordance with the techniques presented herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1-11. (canceled)

12. A computer readable storage medium configured to store computer executable instructions that, in response to execution by a computing system comprising at least one processor, cause the computing system to perform operations, comprising:
identifying a client to determine an eligibility for a financial loan offer amount in association with the client;
searching a first set of data sources to obtain a first set of attributes that is associated with the client;
selecting a set of client data from at least part of the first set of attributes from the first set of data sources;
searching the set of client data against a second set of data sources to obtain a second set of attributes; and
determining a credit worthiness score based on the set of client data and the second set of attributes,
wherein searching the second set of data sources includes searching different data sources than the first set of data sources.

13. The computer readable storage medium of claim 12, the operations further comprising factoring the credit worthiness score for the loan offer amount as a function of a validity score associated with the first set of attributes and the second set of attributes.

14. The computer readable storage medium of claim 13, wherein the searching the first set of data sources includes obtaining financial attributes considered by credit rating agencies for calculating a credit score of the client, and the searching the client data against the second set of attributes includes obtaining personal characteristics determined from the second set of attributes and not included in the first set of attributes.

15. The computer readable storage medium of claim 14, wherein the searching the first set of data sources consists of searching private data sources and the searching the second set of data sources consists of searching publicly available data sources located on a publicly available network.

16. The computer readable storage medium of claim 15, the operations further comprising:
assigning associations between the first set of attributes and the second set of attributes with a rank that determines a validity of the second set of attributes; and
altering the credit worthiness score for the loan offer in response to a third search resulting in different attributes associated with the client than the second set of attributes and different associations among the first and the second set of attributes.

17. The computer readable storage medium of claim 14, wherein determining the personal characteristics includes determining temperament, abilities, and interests of the client.

18. The computer readable storage medium of claim 17, wherein determining the personal characteristics further includes determining data related to associations of the client with other people, credit scores of the other people and a validation strength of the data related to the associations.

19-23. (canceled)

24. A system comprising a memory that stores computer-executable components and a processor, communicatively coupled to the memory, that facilitates execution of the computer-executable components comprising:
means for monitoring e-commerce activity of a client;
means for identifying the client to determine an eligibility for a financial loan offer amount in association with the client;
means for searching a first set of data sources to obtain a first set of attributes that is associated with the client;
means for selecting a set of client data from at least part of the first set of attributes from the first set of data sources;
means for searching the set of client data against a second set of data sources to obtain a second set of attributes, wherein the second set of data sources includes publicly available data sources available on a public network and the first set of data sources includes private data sources; and
means for factoring a credit worthiness score based on the set of client data and the second set of attributes.

25. The system of claim 24, further comprising means for ranking the second set of attribute data associated with the client by analyzing associations among the first set of attribute data and the second set of attribute data stored and for assigning a validity score to the associations.

26. The system of claim 24, wherein the first set of attributes comprise financial attributes considered by a credit rating agency for calculating a credit score of the client, and the second set of attributes includes personal characteristics of the client determined from the second set of attributes that are not included in the first set of attributes.

27. The system of claim 26, wherein determining the personal characteristics includes determining temperament, abilities, and interests of the client.

28. A system, comprising:
a memory that stores computer-executable instructions; and
a processor, communicatively coupled to the memory, that facilitates execution of the computer-executable instructions to at least:
identify a client to determine an eligibility for a financial loan offer in association with the client;
search a first set of data sources to obtain a first set of attributes that is associated with the client;
select a set of client data from at least part of the first set of attributes from the first set of data sources;
search the set of client data against a second set of data sources to obtain a second set of attributes; and
determine a credit worthiness score based on the set of client data and the second set of attributes.

29. The system of claim 28, wherein the processor is further configured to execute the computer executable instructions to:
factor the credit worthiness score for the loan offer as a function of a validity score associated with the first set of attributes and the second set of attributes.

30. The system of claim 28, wherein the first set of attributes comprises financial attributes considered by credit rating agencies for calculating a credit score of the client, and the second set of attributes includes personal characteristics of the client determined from the second set of attributes that are not included in the first set of attributes.

31. The system of claim 30, wherein the personal characteristics comprise a temperament, an ability, and an interest of the client.

32. The system of claim 31, wherein the personal characteristics further include data indicating an association of the client with another person, credit scores of the another person and a validation strength of the data indicating the association.

33. The system of claim 28, wherein the first set of data sources consists of one or more private data sources and the second set of data sources consists of one or more publicly available data sources located on a publicly available network.

34. The system of claim 28, wherein the processor is further configured to execute the computer executable instructions to:
assign associations between the first set of attributes and the second set of attributes with a rank that determines a validity of the second set of attributes; and
alter the credit worthiness score for the loan offer in response to a third search resulting in different attributes associated with the client than the second set of attributes and different associations among the first and the second set of attributes.

35. A method, comprising:
identifying a client for determining an eligibility for a financial loan offer amount in association with the client;
searching a first set of data sources to obtain a first set of attributes that is associated with the client;
selecting a set of client data from at least part of the first set of attributes from the first set of data sources;
searching the set of client data against a second set of data sources to obtain a second set of attributes; and
determining a credit worthiness score based on the set of client data and the second set of attributes.

36. The method of claim 35, further comprising:
factoring the credit worthiness score for the loan offer as a function of a validity score associated with the first set of attributes and the second set of attributes.

37. The method of claim 35, wherein the searching the first set of attributes comprises obtaining financial attributes considered by credit rating agencies for calculating a credit score of the client, and the searching the second set of attributes includes obtaining personal characteristics of the client determined from the second set of attributes that are not included in the first set of attributes.

38. The system of claim 37, wherein the personal characteristics comprise a temperament, an ability, and an interest of the client.

39. The system of claim 35, wherein the first set of data sources consists of one or more private data sources and the second set of data sources consists of one or more publicly available data sources located on a publicly available network.

40. The method of claim 35, further comprising:
assigning associations between the first set of attributes and the second set of attributes with a rank that determines a validity of the second set of attributes; and
altering the credit worthiness score for the loan offer in response to a third search resulting in different attributes associated with the client than the second set of attributes and different associations among the first and the second set of attributes.
